(19) United States
(12) Patent Application Publication
(10) Pub. No.: US 2004/0195166 A1
(43) Pub. Date: Oct. 7, 2004

(54) Grading or filtration device for multi-phase mixtures

(76) Inventor: Helmuth Gabl, Graz (AT)

Correspondence Address: ALIX YALE & RISTAS LLP, 750 MAIN STREET, SUITE 1400, HARTFORD, CT, 06103, US

(21) Appl. No.: 10/480,776

(22) PCT Filed: May 27, 2002
(86) PCT No.: PCT/EP02/05780

(30) Foreign Application Priority Data
Jun. 19, 2001 (AT) A 947/2001

(51) Int. Cl. B01D 29/46

(52) U.S. Cl. 210/331; 210/346; 210/357; 210/488

(57) ABSTRACT

A screening or filtration device for multi-phase mixtures, particularly liquids containing fibers, includes a casing with at least one feed pipe, at least one filtrate discharge pipe, at least one retentate discharge pipe, and at least one filter or screen through which the filtrate flows. The filter or screen being formed at least by an essentially rigid top surface of an at least essentially circular filter disc with hollow interior that can be rotated round an essentially central axis, where the interior of the disc is connected to the filtrate discharge pipe. The device also comprising at least one structural element adjacent to the filter or screen, where guiding and drive facilities are also provided that cause this structural element and the filter disc to describe movement relative to one another parallel to the level of the filter disc.

### CROSS-REFERENCE TO RELATED APPLICATIONS

This is the national stage of International Application No. PCT/EP02/05780, filed Dec. 27, 2002 and which designated the United States.

### BACKGROUND OF THE INVENTION

The invention relates to a screening or filtration device for multi-phase mixtures, particularly liquids containing fibers, comprising a casing with at least one feed pipe, at least one discharge pipe for the liquid treated, at least one discharge pipe for the retentate or impurities, and at least one filter or screening area through which the liquid flows and the rear side of which is connected to the discharge pipe for the liquid treated, with facilities being provided to generate a defined set of flow characteristics at the filter or screening area to which the liquid flows. The invention also relates to a screening or filtration plant.

Until now, devices containing rotating screen baskets or rotors as active plant components have been used for screening of multi-phase mixtures. These screen baskets can be made up of perforated plates, for example, or from a large number of rods with widely differing hole or slot diameters and surface geometries.

### SUMMARY OF THE INVENTION

The purpose of the invention was to provide an advantageous embodiment of a screening and filtration device that permits improved and easy-to-scale screening or filtration performance with as little apparatus as possible, as little process engineering as possible, and at lowest possible cost, as well as to develop a plant that puts these advantages into practice.

In order to achieve this purpose the invention covers a filtration or screening area that is formed at least by an essentially rigid top surface of an at least essentially circular filter disc with hollow interior that can be rotated round an essentially central axis, where the interior of the disc is connected to the discharge pipe for the liquid treated, as well as covering at least one further element immediately adjacent to the filtration or screening area, where guiding and drive facilities are also provided that cause this element and the filter disc to describe a relative movement to one another parallel to the level of the filter disc. As a result of the interplay and the relative movement of the filter disc to the adjacent element it is possible to set advantageous impact geometry at the screening or filtration area, which permits an increase in throughput with the surface area available. At the same time, the flow generated by the relative movement leads to continuous cleaning of the pulp contact surfaces.

If, in an advantageous embodiment, at least two, preferably several, filter discs are arranged in parallel on the same axis, it is possible to achieve an increase in the screening or filtration area and thus, in the throughput of the device, by enlarging in one dimension only.

If the filter discs are arranged essentially horizontally and can perhaps be rotated round an essentially vertically oriented axis, a surface area increase can be achieved although the floor space remains unchanged.

According to an initial embodiment of the invention, the, at least one, further element can be fixed and the, or each, filter disc can be rotated in relation thereto.

As an alternative, in another embodiment there could be at least some fixed filter discs and the, at least one, further element could be mounted such that it is movable in relation thereto.

Of course, other embodiments are also conceivable in which both the, at least one, further element and the, or each, filter disc are mounted such that they are movable in relation to one another.

To obtain the largest possible screening or filtration areas at lowest area or volume requirement for the device, it is an advantage if the, at least one, further element is formed by at least one further filter disc, preferably by several filter discs mounted on one single axis. This provides an arrangement in which each filter disc is the element creating the desired flow characteristics and self-cleaning effect for at least one adjacent filter disc.

In order to obtain the advantages just mentioned with the lowest possible structural volume, the invention provides a further characteristic feature with at least two stacks of filter discs mounted at a set distance one above the other and on parallel axes with a set radial spacing to one another, where the filter discs of one stack are positioned in the spaces between the filter discs of the other stack, where the stacks overlap one another viewed in the direction of the axes, and where at least one of the stacks of filter discs mounted one above the other can be rotated round its own axes.

If, in a preferred embodiment of the invention, the filter discs are formed by perforated plates with a K-profile, this feature can maintain the tendency to clog at a minimum.

In order to influence the flow as little as possible after the medium passes through the screening or filtration area, the filter discs are essentially self-supporting, i.e. free of supporting elements.

A particularly easy means of carrying away the medium passing through the screening or filtration area is provided if the interior of the filter discs is connected to the interior of a hollow supporting structure for the filter discs, particularly the hollow axle with circular filter discs, where the interior of the supporting structure forms the discharge for the liquid. Here, it is a particular advantage if the filter-discs are arranged on an axis that is essentially vertical because the medium can then drain out of the interior of the hollow axle assisted by the force of gravity.

In order to adapt the flow characteristics and/or the self-cleaning effect more precisely, the invention has a further characteristic feature of strips or grooves being provided or formed on the outer surface of the filtration or screening area. These strips or grooves can be of different shapes depending on the desired flow characteristics, as well as on the phases and materials to be separated.

In order to offer different screening stages and provide multi-stage treatments in a simple manner, the plant according to the invention is characterized by at least two devices according to one of the preceding claims, where the discharge from one device is connected to the feed of at least one second device downstream thereof, and where the effective diameter of the perforations in the screening or filtration areas is different in both devices, preferably smaller in the downstream device than in the device preceding it.

### BRIEF DESCRIPTION OF THE DRAWINGS

The invention will now be explained in more detail in the following description, referring to the attached drawings.

FIG. 1 shows a diagrammatic side view of a preferred embodiment of the screening and filtration device according to the invention,

FIG. 2 is a horizontal projection of a different embodiment of the screening and filtration device according to the invention,

FIG. 3 shows a sectional view through one half of a filter disc,

FIG. 4 is a sectional view of a through passage in the filter disc according to an initial advantageous embodiment,

FIGS. 5a and 5b contain sectional and exploded views of surface sectors and through passages, respectively, according to other embodiments, and

FIG. 6 shows a diagrammatic cross-section through a device according to the invention, with a special design of casing.

### DETAILED DESCRIPTION OF THE PREFERRED EMBODIMENT

The screening and filtration device 1 shown as an example in FIG. 1 has several center cores 2, 2′, where each of the preferably vertical shafts 2, 2′ have several filter discs 3 mounted one above the other and at a distance from one another which is greater than the thickness of one disc. The multi-phase mixture to be treated, normally available in the form of an aqueous solution, is fed through at least one feed pipe 5 into the casing 4 that holds the filter discs 3, which casing can be of either open or closed design, e.g. a pressure vessel. In the casing 4, a level is set for the mixture at which all filter discs 3 are completely submerged. The medium passing through the active filtration and screening areas of the filter discs 3 enters the interior of the center cores 2, 2′ and is then carried out of the casing 4 through pipes 6, while the retentate or impurities flow through a discharge pipe 7 out of the casing 4. Depending on the rheological properties of the suspension to be treated, the nature of the content material and the flow conditions—which depend also on the movement by the screening discs 3 and additional elements, preferably the other discs 3 and their surface properties, among other things—the reject is usually drained off at the base of the device. In order to allow the material to flow advantageously without spinning, without turbulence, and with the shortest possible discharge paths for the retentate, the reject can also be removed at the side or in the upper section, preferably at the center above the plant.

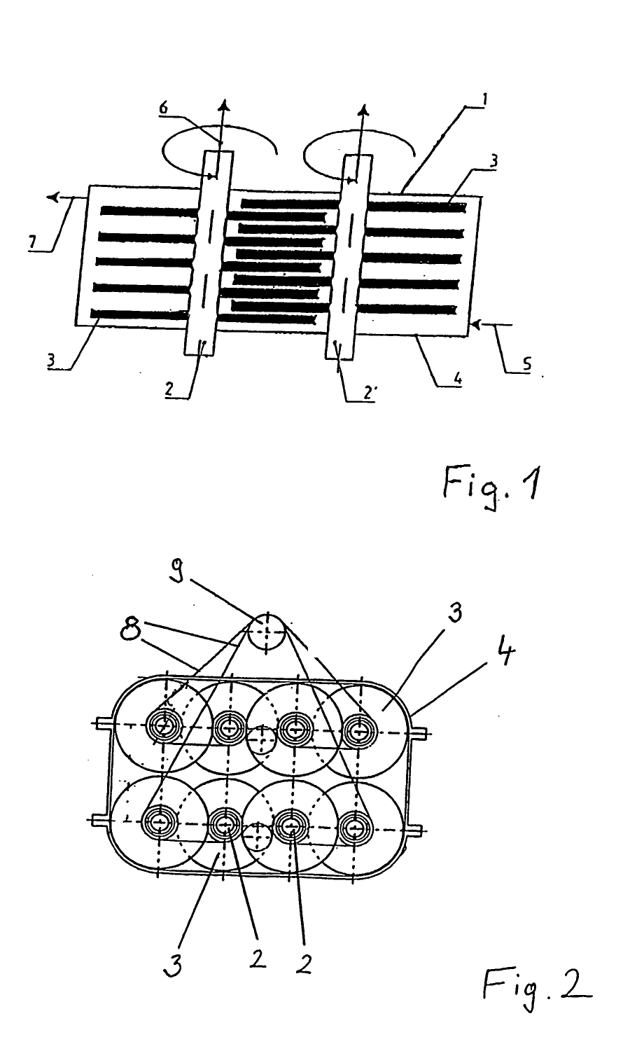

FIG. 1 shows a device with two stacks of screening or filter discs 3, mounted one above the other and at a set distance from one another, where these two stacks are secured to parallel center cores 2, 2′ with a set radial spacing between these center cores 2, 2′, this clearance being measured such that the filter discs of one stack intermesh into the spaces between the filter discs of the other stack. The two stacks of screening or filter discs 3 overlap when viewed in the direction of the center cores 2, 2′ and at least one of the stacks, preferably both stacks, can be rotated round the axis formed by the appropriate center core 2, 2′. A device according to the invention with a total of eight stacks of filter discs 3 is shown as an example in FIG. 2, where the stacks are divided into two rows of four stacks each, with the adjacent stacks in each row intermeshing. Furthermore, FIG. 2 shows the drive belts running preferably over all of the center cores 2 and by means of which a motor 9 can set the center cores 2 in rotation.

As shown diagrammatically in FIG. 3, the screening or filter discs 3 have a cylindrical cross-section and at least one essentially rigid top surface 10 as their screening or filter area, with the opposite bottom surface 11 preferably also being rigid and suitable for use as screening or filter area if necessary. The shell surface 12 is impermeable, and it is an advantage if the interior 13 of the disc 3 is free of internals, such as supporting or spacing elements, making the discs not only easier to assemble, but also providing better hydraulic conditions, as well as ensuring that there is nothing to hinder the medium when passing through the screening or filter area 10 to reach the center of the disc 3 and continuing on to the center core 2. In addition, there is less susceptibility to growth of bacteria and germs.

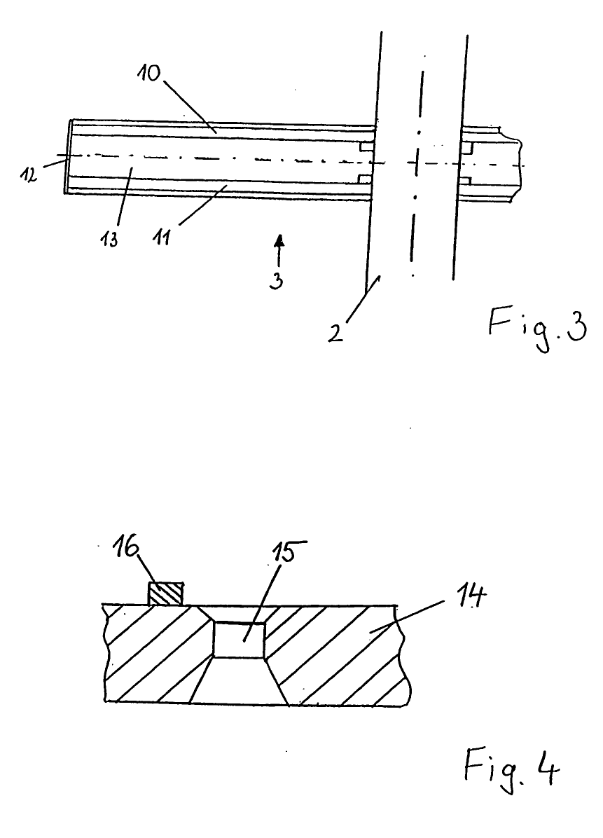

In a preferred embodiment, the rigid top surface 10 or each active screening or filter area is formed by perforated plates 1 4 with a K-profile and whose apertures 15 have very low clogging tendency. The sheet metal thickness is typically in the range of 1 to 6 mm, preferably between 2 and 5 mm. Plastic, ceramic or compound material would, however, also be possible for the discs 3, or the screening or filter area 10, assuming that all materials are also coated, e.g. by chrome or nitration hardening, etc. An example of this is shown in FIG. 4. Furthermore, the outer surface of the filter or screening area 10 has a strip 16 fitted on one side of the perforation 15 which influences the flow characteristics over the surface, depending on the configuration.

FIGS. 5a and 5b show examples of further embodiments of the surface shaping of the screening or filter areas. Thus, the perforations 15 can also be provided in the base of a groove 17 formed in the surface of the discs 3, where this groove can also be located behind a strip 16. The perforations 15 themselves can have various shapes, for example, round, or slotted 15′. The exact progression and shape of the strips 16, grooves 17, perforations 15, and any other additional mountings there may be, can be selected or designed according to the desired flow characteristics and turbulence across the screening or filter area 10 or between the individual discs 3 of the intermeshing stacks. It is an advantage in any case if the perforations is have a cross-section progression as shown in the drawings, which is constant at first as it moves away from the surface 10 on which the flow impacts, but then widens in order to counteract any potential clogging.

The desired flow characteristics across the active surface area 10 of the screening or filter discs 3 are assisted by the preferably relative movement of the discs 3 in the intermeshing stacks. Instead of relative movement by the filter discs 3 of an adjacent stack, however, this movement can also be generated by elements which are not active in the screening or filtration process, for example spoiler strips or bars, vanes or similar elements, which can be installed either in fixed or in movable mountings in the casing 4, as long as the movement in relation to the filter discs 3, also with either fixed or movable mountings, is assured. In principle, the elements provided to cause turbulence and influence flow can have any desired shape and surface form. They may even be of irregular shape. An additional advantage of influencing the flow over the surfaces of the filter or screening discs 3 is also the self-cleaning effect, which also reduces the risk of clogging substantially. A further possible means of cleaning the device, however, is to backwash with accept liquid.

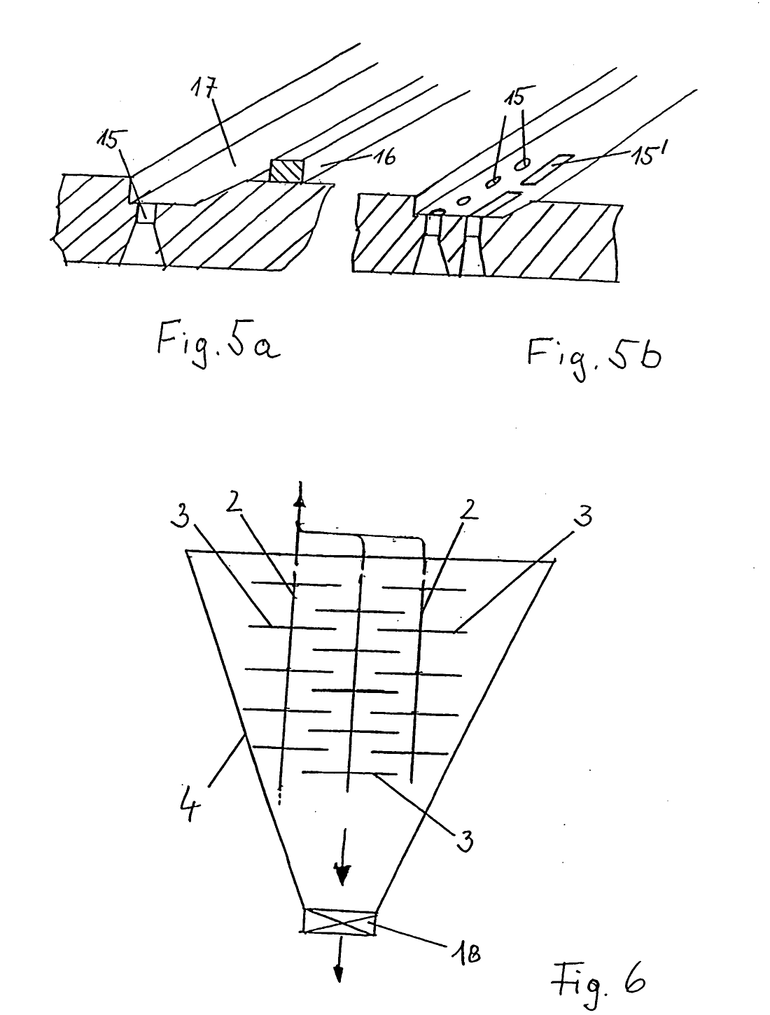

A particularly advantageous shape for the casing 4 is illustrated diagrammatically in cross-section in FIG. 6. For vertical shafts 2, on which the screening or filter discs 3 are mounted with horizontal alignment, a casing 4 can be provided with side walls, possibly also end walls, that converge towards the bottom, which facilitates removal of the retentate and/or impurities that are collected in the funnel-shaped, lower section of the casing 4 and removed from the casing 4 through a conventional discharge device 18.

Of course, it is also possible to connect two or more screening or filter plants in series or in parallel. Serial connection, where the outlet from one device is connected to the inlet of at least one second downstream device, can be used for screening the impurities into several size classifications if the effective diameter of the perforations in the screening or filter areas is different in both devices, preferably smaller in the downstream device than it is in the upstream device.

1. Screening or filtration device for separating a multi-phase mixture into a filtrate and a retentate, comprising a casing, at least one feed pipe, at least one discharge pipe for the filtrate, at least one discharge pipe for the retentate, at least one filter or screen through which the filtrate flows, and means for generating a defined set of flow characteristics at the filter or screen, the filter or screen including a plurality of substantially circular filter discs arranged in parallel to each other on a substantially central first axis, the filter discs being rotatable around the first axis, each of the filter discs defining a space with an adjacent filter disc, each of the filter discs having an exterior defining a hollow interior connected to the filtrate discharge pipe, the exterior of the filter disc including at least one outer surface having bars or grooves, the device also comprising at least one structural element adjacent to the filter or screen and guiding and drive means for causing the structural element and the filter discs to describe movement relative to one another parallel to the level of the filter discs.

2. Device according to claim 1, wherein the at least one structural element comprises at least one filter disc.

3. Device according to claim 2, wherein the structural element comprises a plurality of filter discs arranged in parallel to each other on a substantially central second axis, each of the filter discs of the structural element defining a space with an adjacent filter disc, the filter discs of the screen or filter being positioned in the spaces between adjacent filter discs of the structural element and the filter discs of the structural element being positioned in the spaces between adjacent filter discs of the screen or filter, wherein the filter discs of the screen or filter and the filter discs of the structural element.

4. Device according to claim 1 wherein the outer surfaces of the filter discs are perforated plates having perforations with a K-profile.

5. Screening or filtration plant comprising at least a first and a second screening or filtration device for separating a multi-phase mixture into a filtrate and a retentate, each of the screening or filtration devices comprising a casing, at least one feed pipe, at least one discharge pipe for the filtrate, at least one discharge pipe for the retentate, and at least one filter or screen through which the filtrate flows, the filter or screen including a plurality of substantially circular filter discs arranged in parallel to each other on a substantially central axis, the filter discs being rotatable around the axis, each of the filter discs having an exterior defining a hollow interior connected to the filtrate discharge pipe, the exterior of the filter disc including at least one outer surface formed from a perforated plate and having bars or grooves, the device also comprising at least one structural element adjacent to the filter or screen and guiding and drive means for causing the structural element and the filter discs to describe movement relative to one another parallel to the level of the filter discs, wherein the filtrate discharge pipe from the first screening or filtration device is connected to the feed pipe of at least the second screening or filtration device, where the effective diameter of the perforations in the perforated plates of the second screening or filtration device are smaller than in the perforations in the perforated plates of the first screening or filtration device.

6. Device according to claim 1, wherein the at least one structural element comprises at least one filter disc mounted on a substantially central second axis, the at least one filter disc being rotatable around the second axis.

7. Device according to claim 1, wherein the at least one structural element comprises at least one filter disc mounted on a substantially central second axis, the at least one filter disc being stationary.

8. Device according to claim 1, wherein the at least one structural element comprises a plurality of filter discs mounted on a substantially central second axis, the filter discs being rotatable around the second axis.

9. Device according to claim 1, wherein the at least one structural element comprises a plurality of filter discs mounted on a substantially central second axis, the filter discs being stationary.
